(19) United States
(12) Patent Application Publication
(10) Pub. No.: US 2005/0129579 A1
(43) Pub. Date: Jun. 16, 2005

(54) System and method for analysing laboratory samples

(75) Inventor: Allan D. Morrison, Acacia Ridge (AU)

Correspondence Address: HESLIN ROTHENBERG FARLEY & MESITI PC, 5 COLUMBIA CIRCLE, ALBANY, NY, 12203, US

(73) Assignee: Bizpac (Australia) Pty Ltd., Queensland (AU)

(21) Appl. No.: 10/982,539

(22) Filed: Nov. 5, 2004

(30) Foreign Application Priority Data
Nov. 5, 2003 (AU) 2003906081

(51) Int. Cl. B01L 3/00

(52) U.S. Cl. 422/99

(57) ABSTRACT

A sampling assembly (30) for removing a portion of a sample (40) impregnated in designated areas of a medium such as filter card (37) supported in a frame (39); said assembly comprising a punch and die mechanism having a punch (32) movable into a hole (34) provided in the die (33); locating means (31) for positioning the punch and die mechanism relative to designated areas of the filter card; and a raised section (35) provided on said die and arranged to directly support the filter card medium adjacent to the portion of the sample (40) during removal of said portion from the filter card (37).

### CROSS-REFERENCE TO RELATED APPLICATIONS

This application claims the benefit of Australian Provisional Patent Application No. 2003906081 filed Nov. 5, 2003, which application is herein incorporated by reference in its entirety.

### BACKGROUND OF THE INVENTION

1. Field of the Invention

This invention relates to a system and method for analysing laboratory samples. The invention has particular but not exclusive application to punching out for testing purposes samples from a filter paper on which liquid biological samples have been dried.

2. Discussion of the Background Art

It is known for laboratory samples that are normally in a liquid state to be dried on filter paper for ease of transport and storage. One such application involves a filter paper card format where the card has the same footprint as an SBS laboratory-standard plate having 96 sample sites.

The present applicant's earlier International Patent Publication No. WO 99/65625 describes a punching apparatus having a punch and a die for punching out portions of samples retained on paper media. It has been found that, in the case of paper and other fine grade materials to be punched, the clearances required between the outside diameter of the punch and the inside diameter of the hole in the die are very tight, being in the order of 10 microns.

Frames or similar peripheral support arrangements for paper cards or other media for retaining samples are presently under development. Typically these support arrangements result in the medium being suspended at its periphery. These arrangements present further difficulties in punching portions of samples cleanly and effectively from a sample medium, due to difficulties in effectively accessing or supporting the medium at the desired sample sites.

### SUMMARY OF THE INVENTION

Object of the Invention

The present invention aims to provide an alternative to known systems and methods of the above type, which addresses these and other problems.

Disclosure of the Invention

This invention in one aspect resides broadly in a system for analysing laboratory samples wherein samples to be tested are impregnated in designated areas on a sheet such as a filter card or like medium, the system comprising:
a frame supporting the filter card for the manipulation and transport thereof;
a sampling assembly for removing a portion of the sample impregnated in the designated areas on the filter card, wherein said sampling assembly includes:
   a punch and die mechanism having a punch movable into a hole provided in the die;
   locating means for positioning the punch and die mechanism relative to the designated area; and
   wherein said die is arranged to directly support the medium during removal of said portion of the sample from the filter card.

Suitably, the die includes a raised section to directly support the medium adjacent to said portion of the sample in a designated area.

In another aspect, the invention resides in a sampling assembly for removing a portion of a sample impregnated in designated areas of a medium, suitably filter card, supported in a frame; said assembly comprising:
a punch and die mechanism having a punch movable into a hole provided in the die;
locating means for positioning the punch and die mechanism relative to the designated area of the filter card; and
a raised section provided on said die and arranged to directly support the medium adjacent to the portion of the sample during removal of said portion from the filter card.

Preferably, the raised section of the die is arranged such that the sampling assembly conveniently provides clearance for the frame supporting the filter card.

A periphery of the raised section of the die may include surfaces sloping outwardly and downwardly from the hole in the die.

Suitably, the sampling assembly includes a guide member having a bore for the punch and an opposing die member incorporating the hole, which guide member and die member are either fixed together or integrally formed. Most suitably, the guide member and opposing die member define a mouth or slot for insertion of the frame.

If required, first and second inert layers juxtaposing opposite surfaces of the filter card are provided for the protection thereof.

Apertures may be provided in at least one inert layer positioned to substantially overlay the designated areas when the inert layers and the filter card juxtapose.

It is preferred that the apertures are substantially square.

It is also preferred that the corners of the substantially square apertures are rounded and the designated areas on the filter card are substantially circular, the length of the side of the square substantially corresponding with the diameter of the substantially circular designated areas.

It is preferred that there are apertures in each inert layer and that the sampling assembly includes a punch and die assembly, locating means positioning the punch and die assembly relative to the designated area.

It is also preferred that the punch is positioned adjacent one of the inert layers and the die is positioned adjacent the other inert layer, the locating means being the apertures in the respective inert layers.

It is also preferred that the punch is adapted to remove a portion of the sample which is substantially smaller than the designated area such that a plurality of samples can be removed from a designated area.

It is also preferred that the die has a single recess for cooperating with the punch to receive the removed portion, the die and the punch both moving relative to the filter card and being positioned prior to punching by engagement with the respective apertures in both inert layers.

It is to be understood that references to movement of the punch and die relative to the filter card include movement of the filter card relative to a stationary punch and die assembly.

Alternatively, the die can have a plurality of recesses for cooperating with the punch to receive the removed portion, the punch moving relative to the filter card and the die, and being positioned prior to punching by engagement with an aperture in the one inert layer, the die being in engagement with an aperture in the other inert layer.

It is also preferred that the apertures in the other inert layer which locate the die are substantially frustro-conical, the portion of the die adapted to engage these apertures being correspondingly frustro-conical.

Alternatively, the apertures in the other inert layer which locate the die can be slightly larger than the apertures in the one inert layer which locate the punch.

In another embodiment the sampling assembly can include a corer for removing the portion of the sample by coring. In this embodiment it is preferred that there are apertures in only one layer, the other layer constituting a backing.

The corer can optionally include a rotating hollow coring tool.

In another aspect this invention resides broadly in a method of analysing laboratory samples wherein samples to be tested are impregnated in designated areas on a filter card or the like supported in a frame, the method comprising:
providing a sampling assembly having a punch and die mechanism having a punch movable into a hole provided in the die;
positioning the punch and die mechanism relative to a selected designated area with a locating means of the sampling assembly;
directly supporting the medium with a raised section provided on said die; and
removing from the filter card a portion of the sample impregnated in the designated areas thereon, said portion of the sample being removed by punching the portion into the die.

If required, the method may include the steps of juxtaposing first and second inert layers adjacent opposite surfaces of the filter card for the protection thereof;
forming apertures in at least one inert layer, the apertures being positioned to substantially overlay the designated areas when the inert layers and the filter card juxtapose.

It is preferred that the apertures are substantially square.

It is also preferred that the method includes positioning a punch adjacent one of the inert layers and positioning a die adjacent the other inert layer by locating the punch and die in the apertures in the respective inert layers.

In a further aspect this invention resides broadly in a filter card assembly for analysing laboratory samples, the assembly comprising:
a filter card or the like whereon samples to be tested can be impregnated in designated areas,
first and second inert layers juxtaposing opposite surfaces of the filter card for the protection thereof, and
apertures in at least one inert layer positioned to substantially overlay the designated areas when the inert layers and the filter card juxtapose.

It is preferred that the apertures are substantially square.

It is also preferred that there are apertures in each inert layer respectively adapted to locate a punch positioned adjacent one of the inert layers and a die positioned adjacent the other inert layer.

In an alternative embodiment there are apertures in only one layer adapted to locate a cover positioned adjacent the one inert layer, the other layer constituting a backing.

### BRIEF DETAILS OF THE DRAWINGS

In order that this invention may be more easily understood and put into practical effect, reference will now be made to the accompanying drawings which illustrate a preferred embodiment of the invention, wherein:

FIG. 1 is a partial plan view of a filter plate assembly in accordance with a preferred embodiment of present invention showing four substantially square cut-outs in the upper protective layer;

FIG. 2 is a cross sectional elevation of the filter plate assembly of FIG. 1 showing the filter paper sandwiched between the upper and lower protective layers;

FIG. 3 is a cross sectional view corresponding to that shown in FIG. 2 and schematically illustrating a representative arrangement of a punch and die assembly for removing samples from the filter paper in accordance with a preferred embodiment of the present invention;

FIG. 4 is a partial plan view of a filter plate assembly showing four substantially circular cut-outs in the upper protective layer;

FIG. 5 is a cross sectional elevation of the filter plate assembly of FIG. 4 showing the filter paper sandwiched between the upper and lower protective layers;

FIG. 6 is a cross-sectional elevation showing another preferred embodiment of a filter plate assembly in which the filter paper is sandwiched between an upper protective layer having cut-outs or apertures therein and a lower hard base protective layer, together with a coring device for removing samples from the filter paper;

FIG. 7 is a cross-sectional elevation showing a further preferred embodiment of a sampling apparatus including a punch and die mechanism;

FIG. 8 is a top plan view of the sampling apparatus of FIG. 7;

FIG. 9 is an enlarged side elevation of the die member of the sampling apparatus of FIG. 7;

FIG. 10 is a side elevation of a still further preferred embodiment of a sampling apparatus, adapted for use with relatively bulky supporting frames; and

FIG. 11 is a partial plan view of the die member of the sampling apparatus of FIG. 10.

### DESCRIPTION OF EMBODIMENTS OF THE INVENTION

In order to minimise the risk of cross-contamination and to aid automated handling in a system and method as described above, an inert medium 11, 12 is placed on either side of a sheet medium such as a filter card 13 and touching the card, either in a frame, or attached directly to the card.

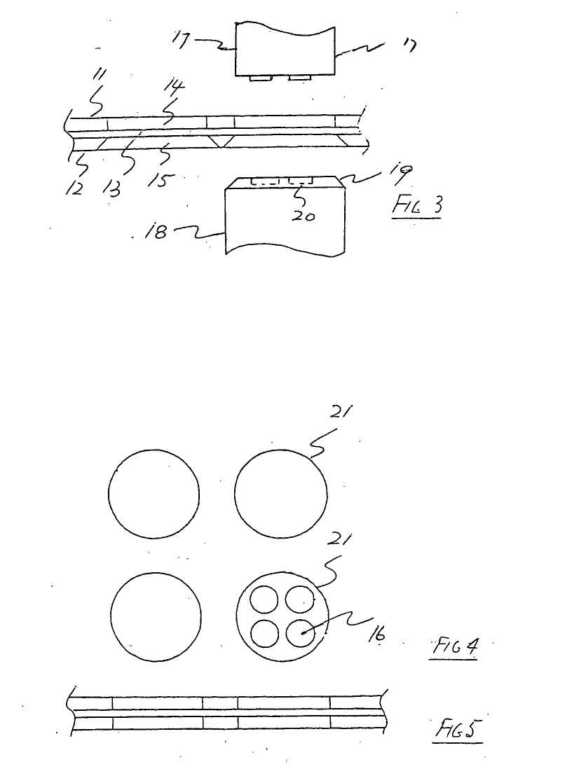

To enable small parts of the dried biological sample (such as blood, urine or saliva) in the 96 sample sites to be punched out for testing purposes, the inert medium 11, 12 on each side of the card includes holes 14, 15 respectively to allow a punch and die mechanism 17, 18 (as seen schematically in FIG. 3 or in FIG. 7) to access the cards and sample sites.

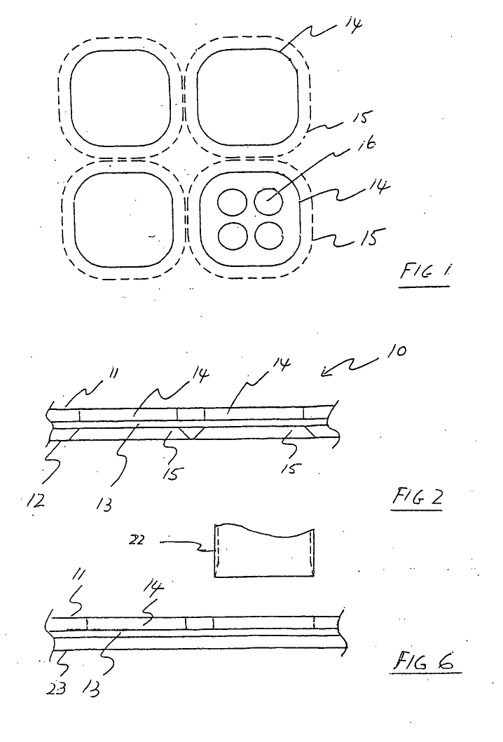

In some applications it may be desired to punch out and remove disks of sample material with smaller diameter than the diameter of the sample site disc itself. Such sample site discs are typically 13 mm diameter and the smaller sample discs (as seen at 16 in FIG. 1) could be for example, 2 mm diameter.

It has been found that a particular shape of holes 14, 15 in the inert medium on each side of the card is most suitable for this automated punching purpose, given the nature of a typical punch and die operation. This particular shape is seen in FIG. 1 as being substantially square. The corners of the square can be slightly rounded and in the example shown the radius of curvature of the corners is 2.5 mm.

To facilitate the small disks being cut cleanly from the card, the punch 17 and the die 18 is positioned immediately adjacent to the card 13 at the time of punching. Support members for the punch and the die are fixed relative to one another, such as by mounting to a common C-shaped guide block 31 of a sampling assembly 30 of the embodiment depicted in FIG. 7. This embodiment is discussed in more detail below.

In view of the clearance within which the punch 17 and die 18 are normally required to operate, for example in the order of 10 microns, separate support members for punch and die that are independently movable in the x-y plane are considered uneconomic. Accordingly, a locating means (not shown) is provided for the C-shaped guide block 31, as desired, under program control.

While the particular shaped hole 14 in the upper medium 11 assists in allowing the punch to access the sample, a complementary die can also be used, such that the die incorporates a special raised section 19 that fits into the shaped hole 15 in medium 12 beneath the card 13.

In some applications, the raised section 19 of the die plate 18 could incorporate four punching holes 21, corresponding to the maximum number of 2 mm disks to be cut from the sample. In this case, the punch 17 would move in an x y direction, relative to the card 13 and die plate 18.

In some other applications, the raised section 19 of the die plate 18 could be smaller and incorporate one punching hole 20 only, in which case, the raised section 19 of the die plate 18 and the punch 17 could move in an x-y direction, relative to the card 13.

In both of the above cases, the card 13 and die plate 18 would move in a z axis relative to the other, to allow for the re-positioning of the card 13 on the raised die section 19.

The shaped hole 15 in the medium 12 beneath the card can, in some applications, have a sloping or chamfered inner face as seen in FIG. 2.

It will be appreciated that the shape of the opening 14 in the upper medium 11 as seen in FIG. 1, in comparison with the circular shaped opening 21 as illustrated in FIGS. 4 and 5, provides a greater integrity to the sample in that whereas in the FIG. 4 arrangement, 2 mm diameter discs centred 2.5 mm apart are only 0.48 mm from the periphery of a 13 mm circular cut-out, in the arrangement illustrated in FIG. 1 similarly located 2 mm discs are 1.25 mm from the periphery of the substantially square cut-out with rounded corners.

Thus with reference to FIGS. 1-3, the system of the present invention has samples to be tested which are impregnated in designated areas on a filter card 13. The system has first and second inert layers 11, 12 juxtaposing opposite surfaces of filter card 13 for protecting the filter card. Apertures 14, 15 in the inert layers 11, 12 are positioned to substantially overlay the designated areas when the inert layers 11, 12 and the filter card 13 juxtapose as seen in FIGS. 2 and 3. As described above and subsequently in more detail, a sampling assembly removes a portion of the sample impregnated in the designated areas on the filter card 13.

As seen in FIG. 1, the apertures 14 are substantially square with the corners of the substantially square apertures being rounded. The designated areas on the filter card 13 are substantially circular and the length of the side of the square 14 substantially corresponds with the diameter of the substantially circular designated areas.

The sampling assembly includes a punch and die assembly 17, 18 (as in FIG. 3) and locating means position the punch and die assembly relative to the designated area on filter card 13. Punch 17 is positioned adjacent inert layer 11 and die 18 is positioned adjacent the other inert layer 12, the locating means being the apertures 14, 15 in the respective inert layers 11, 12.

Punch 17 is adapted to remove a portion of the sample which is substantially smaller than the designated area, such that a plurality of samples can be removed from a designated area.

Die 18 may have a single recess 20 for cooperating with punch 17 to receive the removed portion, the die 18 and the punch 17 both moving relative to the filter card 13 and being positioned prior to punching by the respective apertures 14, 15 in both inert layers 11, 12.

Alternatively as seen in FIG. 3, die 18 can have a plurality of recesses 20 for cooperating with punch 17 to receive the removed portion. Punch 17 is positioned prior to punching by an aperture 14 in inert layer 11, die 18 having been positioned in an aperture 15 in the other inert layer 12.

The apertures 15 in inert layer 12 which locate die 18 are substantially frustro-conical and the portion 19 of die 18 adapted to engage these apertures 15 is correspondingly frustro-conical.

Alternatively in an embodiment not illustrated, the apertures 15 in inert layer 12 which locate die 18 are slightly larger than apertures 14 in inert layer 11 which locate punch 17. Suitably the side of apertures 15 are 8 mm and the side of apertures 14 are 7 mm.

The filter card assembly for analysing laboratory samples in accordance with a further aspect of this invention is thus seen to include a filter card 13 whereon samples to be tested can be impregnated in designated areas. First and second inert layers 11, 12 juxtapose opposite surfaces of the filter card 13 for the protection thereof. Apertures 14, 15 in the inert layers 11, 12 substantially overlay the designated areas when the inert layers and the filter card juxtapose. Apertures 14, 15 are substantially square and are adapted to locate a punch 17 positioned adjacent inert layer 11 and a die 18 positioned adjacent the other inert layer 12.

In use, the method of another aspect of the present invention provides for the analysis of laboratory samples which have been impregnated in designated areas on a filter card 13. First and second inert layers 11, 12 are juxtaposed adjacent opposite surfaces of the filter card 13 to protect the card. Apertures 14, 15 are formed in the inert layers 11, 12 and positioned to substantially overlay the designated areas when the inert layers 11, 12 and the filter card 13 juxtapose. A portion of the sample impregnated in the designated areas on the filter card is removed by positioning a punch 17 adjacent inert layer 11 and positioning a die 18 adjacent the other inert layer 12. Punch 17 and die 18 are located in the apertures 14, 15 in the respective inert layers 11, 12 and the portion of the sample is removed by punching the portion into die 18.

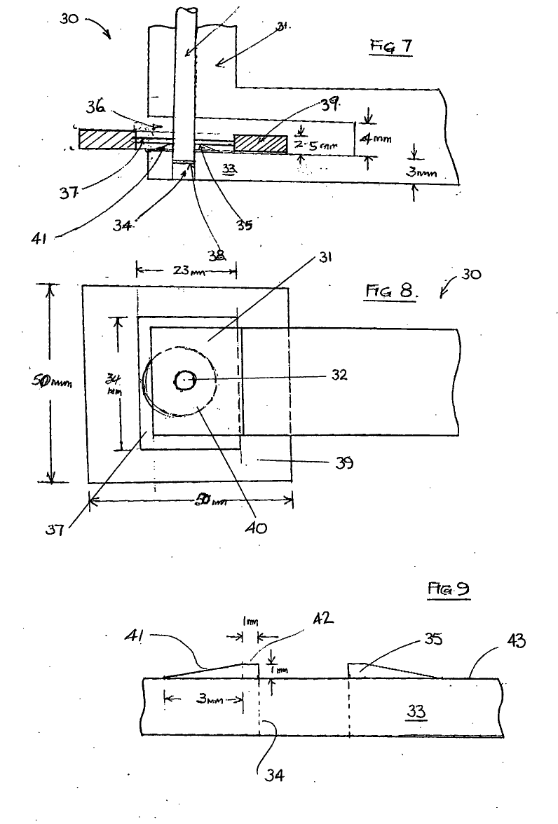

Alternatively, as seen in FIG. 6, in another preferred embodiment of the invention, the method of this other aspect of the invention provides for the analysis of laboratory samples which have been impregnated in designated areas on a filter card 13. First and second inert layers 11, 12 are juxtaposed adjacent opposite surfaces of the filter card 13 to protect the card. Apertures 14 are formed in the inert layers 11 and positioned to substantially overlay the designated areas when the inert layers 11, 12 and the filter card 13 juxtapose. Inert layer 23 is relatively stiff and constitutes a backing. A portion of the sample impregnated in the designated areas on the filter card is removed by positioning a corer 22 adjacent inert layer 11 and then in the apertures 14 in inert layers 11. The portion of the sample is then removed by operating the corer 22 in either rotating or reciprocating fashion.

A further embodiment of the system of the invention is depicted in FIGS. 7 to 9, which system includes a sampling apparatus 30 configured for operation with a frame 39 supporting a sheet medium 37 including a filter card. Indicative dimensions are included on the drawings (which are not to scale) to provide an appreciation of relative sizes. For example, the frame 39 is approximately 50 mm square, having a central window of about 34 mm wide by 23 mm long wherein the medium 37 carrying a sample 40 is exposed. This frame is similar in size to frames otherwise employed to hold photographic slides, and thus are widely available.

The sampling apparatus 30 provides a common support assembly for a punch 32, which travels in a bore provided in a guide member 31, and a die member 33, which includes a die hole 34 arranged co-axially with the punch bore. The support assembly has a generally C-shaped configuration wherein the mouth of the C is constituted by a slot 36 arranged to receive the frame 39, whilst the arms of the C are constituted by the guide member 31 and the opposing die member 33.

The guide member 31 guides the direction of the punch 32, which in this example has a 3 mm diameter cylindrical configuration, and moves from one side of the medium 37 to the other side, by extending out of the bore and into the die hole 34 in the opposing die member 33, thereby punching out a disk 38 retaining a portion of a designated area of the sample 40. The die member 33 includes a raised section 35 arranged to directly support the medium 37 adjacent the portion to be punched and removed from the sample 40. The medium 37 would otherwise be suspended in the frame 39, by virtue of the frame resting on an upper surface of the die member 33, as evident from FIG. 7.

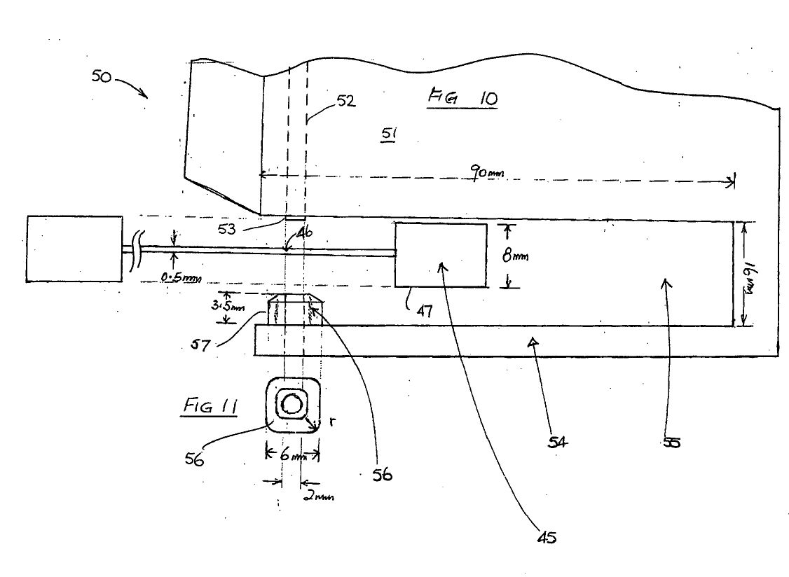

An enlarged view of the raised section 35 of the die member 33 is shown in FIG. 9. The raised section 35 of the embodiment includes an annular portion 42 disposed circumferentially with respect to the die hole 34 and an inclined portion 41 extending from the annular portion down to the upper face 43 of the die member 33. The annular portion has a height of 1 mm above the upper face 43. The angle of the inclined portion is desirably about 10°, such that the frame 39 carrying the filter card 37 can be easily introduced into the 4 mm high slot 36, either manually or by machine.

Whilst the guide member and the die member are integrally formed in the support assembly of embodiment, it will be appreciated that separate guide and die members may be fixed together in other embodiments. The guide and die members are desirably integral or fixed relative to one another to achieve the accuracies and clearances required as part of the operation of punching a fine gauged medium. In order for such punching apparatus to operate effectively, the punch and die mechanism is desirably manufactured so that the bore of the guide 31 and the hole 34 in the die 33 are desirably created at the same time and in the same process, often by machining.

A further embodiment of the system of the invention, which employs a physically larger frame, is shown in FIG. 10. In this embodiment, the sampling apparatus 50 is adapted for use with a medium 46 supported in a frame 45 that is approximately 8 mm in height, thereby suspending the medium some 4 mm to 5 mm above a lowermost surface of the frame.

The sampling apparatus 50 here includes an upper guide member 51 having a bore 52 for guiding a punch 53. The support assembly further includes a lower die member 54 defining a mouth or slot 55, which slot is approximately 16 mm high and 90 mm deep to accommodate a medium 46 having a greater length dimension. The medium may suitably be up to about 75 mm long.

In this example, and in other examples where disks (not shown) are to be punched from the medium in close proximity to the edge of a supporting frame, it is less than practical to provide the die member with a raised portion having a gentle incline to the raised section, as has been done in the embodiment of FIGS. 7 to 9. Instead, in FIG. 10, the raised section 56 has substantially upright sides 57 which may be vertical or near to vertical. In this case, the frame 45 may be lifted in the card slot 55 (either manually or mechanically) so that the lowermost surface 47 of the frame 45 is clear of the raised section 56, allowing insertion of the frame 45 and medium 46 into the card slot 55.

Once the lower surface 47 of the frame moves past the raised section 56, the frame can be lowered onto the die plate or die member 54. The raised section 56 of the die member will then support the medium 46 suspended in the frame 45 adjacent to the area to be removed from the medium by the punch 53. A plan view of the raised section 56, which has a square shape with radiused corners to facilitate access to corners of the medium 47 in proximity to the frame 45, is depicted in FIG. 11

The frame can then be moved to various positions within the card slot 55, suitably by a mechanical locating means such as a pneumatic actuator (not shown), to allow for punching out portions or disks of the medium 46 from different places in a designated area of the sample. Alternatively, it will be appreciated that the sampling apparatus 50 may be moved relative to the frame 45.

The direct support of the medium by the die, suitably a raised section of the die dimensioned in accordance with a frame supporting a filter paper or like medium, reduces the chance of tearing of the medium and thus promotes clean punching of disks retaining a portion of the sample. It will be appreciated that the medium may further comprise inert layers applied to either or both faces of the filter card, as required.

It will of course be realised that whilst the above has been given by way of an illustrative example of this invention, all such and other modifications and variations hereto, as would be apparent to persons skilled in the art, are deemed to fall within the broad scope and ambit of this invention as is set forth herein and defined in the claims which follow.

1. A sampling assembly for removing a portion of a sample impregnated in designated areas of a filter card or other medium supported in a frame; said assembly comprising:
a punch and die mechanism having a punch movable into a hole provided in the die;
locating means for positioning the punch and die mechanism relative to the designated areas of the medium; and
a raised section provided on said die and arranged to directly support the medium adjacent to the portion of the sample during removal of said portion from the filter card.

2. The sampling assembly as claimed in claim 1 wherein the raised section of the die is arranged such that the sampling assembly provides clearance for the frame supporting the medium.

3. The sampling assembly as claimed in claim 1 wherein a periphery of the raised section of the die includes surfaces sloping outwardly and downwardly from the hole in the die.

4. The sampling assembly as claimed in claim 1 wherein the sampling assembly includes a guide member having a bore for the punch and an opposing die member incorporating the hole, which guide member and die member are either fixed together or integrally formed.

5. The sampling assembly as claimed in claim 4 wherein the guide member and opposing die member define a mouth or slot for insertion of the frame.

6. The sampling assembly as claimed in claim 1 wherein a first inert layer and a second inert layer are provided in juxtaposition with respective opposite surfaces of the filter card for the protection of said opposite surfaces.

7. The sampling assembly as claimed in claim 1 wherein apertures are provided in at least one inert layer positioned to substantially overlay the designated areas when the inert layers and the filter card juxtapose.

8. The sampling assembly as claimed in claim 7 wherein said apertures are substantially square.

9. The sampling assembly as claimed in claim 8 wherein the corners of the substantially square apertures are rounded, the designated areas on the filter card are substantially circular, and the length of the side of the square substantially corresponds with the diameter of the substantially circular designated areas.

10. The sampling assembly as claimed in claim 7 wherein apertures are provided in each inert layer and that the sampling assembly includes a punch and die assembly, locating means positioning the punch and die assembly relative to the designated area.

11. The sampling assembly as claimed in claim 7 wherein the punch is positioned adjacent one of the inert layers and the die is positioned adjacent the other inert layer, the locating means being the apertures in the respective inert layers.

12. The sampling assembly as claimed in claim 1 wherein the punch is adapted to remove a portion of the sample which is substantially smaller than the designated area such that a plurality of samples can be removed from a designated area.

13. The sampling assembly as claimed in claim 7 wherein the die has a single recess for cooperating with the punch to receive the removed portion, the die and the punch both movable relative to the filter card and positionable prior to punching by engagement with respective apertures in both inert layers.

14. The sampling assembly as claimed in claim 1 wherein movement of the filter card occurs relative to a stationary punch and die assembly.

15. The sampling assembly as claimed in claim 1 wherein the die includes a plurality of recesses for cooperating with the punch to receive the removed portion, the punch moving relative to the filter card and the die, and being positioned prior to punching by engagement with an aperture in the one inert layer, the die being in engagement with an aperture in the other inert layer.

16. The sampling assembly as claimed in claim 15 wherein apertures in the other inert layer which locate the die are substantially frustro-conical, the portion of the die adapted to engage these apertures being correspondingly frustro-conical.

17. The sampling assembly as claimed in claim 15 wherein apertures in the other inert layer which locate the die are slightly larger than the apertures in the one inert layer which locate the punch.

18. The sampling assembly as claimed in claim 1 wherein the sampling assembly includes a corer for removing the portion of the sample by coring.

19. The sampling assembly as claimed in claim 18 wherein apertures are provided in only one layer, the other layer constituting a backing.

20. The sampling assembly as claimed in claim 18 wherein the corer includes a rotating hollow coring tool.

21. A system for analysing laboratory samples wherein samples to be tested are impregnated in designated areas on a filter card or like medium, the system comprising:
a frame supporting the filter card for the manipulation and transport thereof;
a sampling assembly for removing a portion of the sample impregnated in the designated areas on the filter card, wherein said sampling assembly includes:
a punch and die mechanism having a punch movable into a hole provided in the die;
locating means for positioning the punch and die mechanism relative to the designated area; and
wherein said die is arranged to directly support the medium during removal of said portion of the sample from the filter card.

21. The system as claimed in claim 1 wherein, the die includes a raised section to directly support the medium adjacent to said portion of the sample in a designated area.
